(19) United States
(12) Patent Application Publication
(10) Pub. No.: US 2018/0197370 A1
(43) Pub. Date: Jul. 12, 2018

(54) Gaming Machine and Method Incorporating Display of Possible Future Events

(71) Applicant: Ainsworth Game Technology Limited, Newington (AU)

(72) Inventors: Jason Babler, Las Vegas, NV (US); Jason Pawloski, Las Vegas, NV (US)

(21) Appl. No.: 15/404,594

(22) Filed: Jan. 12, 2017

(51) Int. Cl. G07F 17/32

(52) U.S. Cl. CPC G07F 17/3244; G07F 17/3258; G07F 17/3227; G07F 17/3211

(57) ABSTRACT

A gaming machine includes a display, a value input, and an electronic controller. The controller is configured to determine if a wager has been received, and to display a first game. The controller is also configured to display a set of two or more awards separate from the first game, each award in the set associated with a trigger. If the trigger occurs, the award is provided. Each award in the set is displayed in a queue from lowest to highest according to when a determination will be made whether the trigger has occurred. The controller is configured to index to a subsequent award in the set and display the index each time a determination is made whether the trigger has occurred, and to change the set at least when the determination is made whether the trigger associated with the highest order award has occurred.

### BACKGROUND

This patent is directed to a gaming machine and method incorporating the display of possible future events, and in particular to a gaming machine and method incorporating the display of possible future awards, such as progressive jackpots.

The following discussion of the prior art is intended to present the invention in an appropriate technical context and allow its advantages to be properly appreciated. Unless clearly indicated to the contrary, however, reference to any prior art in this specification should not be construed as an express or implied admission that such art is widely known or forms part of common general knowledge in the field.

Conventional gaming machines provide a base or main game where various configurations of game symbols are displayed on a screen, with the game symbols typically organized into three rows and five columns (a 5×3 array). Other arrays, such as a 3×3 or 4×3, may be used in the alternative. The gaming machine may randomly select the game symbols that appear in or on the array, each column of the array being a “reel”, and provide an award based on the randomly selected configuration. Alternatively, the gaming machine may select an outcome from a pool of outcomes, display a configuration of symbols in accordance with that outcome, and provide an award in accordance with the outcome.

Whether the outcome is determined by a random number generation or a pool of outcomes (or some other mechanism), there exists a set of rules that are consistently applied to the operation of the gaming machine. While the consistent operation of the machine is desirable from a regulatory perspective, the consistent operation of the machine according to the single set of rules may be viewed as staid, boring and redundant by the player. It is desirable to achieve variation in the operation of the machine, so that the player will view the machine as exciting and unique.

To this end, a gaming machine may operate to provide bonus or feature games in addition to a base or main game. These bonus or feature games can use the same set of reels as the main game, but with different rules and/or different probabilities relative to the appearance of certain outcomes. By providing a bonus or feature game in addition to the base or main game, the operation of the gaming machine may be varied so that the player is provided opportunities to receive an award that differ from the opportunities provided when the gaming machine is operating according to the base or main game.

A gaming machine that provides both a main game and a bonus game may provide additional options for variation relative to the gaming machine that provides only a main game. Still, the range of the variation of the gaming machine is limited where the bonus game relies on the same set of reels used in the main game.

It is an object of the present invention to overcome or substantially ameliorate one or more of the disadvantages of prior art, or at least to provide a useful alternative.

### SUMMARY

The present invention provides a gaming machine that has improved operation and performance relative to existing prior art gaming machines. As such, the gaming machine and associated method according to the invention provides an improved gaming machine in that the award of enhanced prizes is performed differently and in a more entertaining manner compared to presently existing gaming machines

One embodiment provides a gaming machine comprising:

at least one display; and

at least one electronic controller coupled to the at least one display, the at least one controller configured:

to display a first game on the at least one display including one or more configurations of game symbols, one or more of the configurations of game symbols being associated with a game outcome, the game outcome being associated with a value award payable to a player;

to display a set of two or more awards on the at least one display separate from the first game,

each award in the set associated with a trigger event, wherein if the trigger event occurs, the award is provided to the player,

each award in the set displayed in a queue from a lowest order award to a highest order award in the set according to when a determination will be made whether the trigger event associated with each award has occurred;

to index to a subsequent award in the set and display the index to the subsequent award each time a determination is made whether the trigger event associated with a previous award has occurred; and

to change the displayed set at least when the determination is made whether the trigger event associated with the highest order award in the displayed set has occurred.

A further embodiment provides a gaming machine comprising:

at least one electronic video display; and

at least one electronic controller coupled to the at least one electronic video display, the at least one controller configured:

to display a first game on the at least one electronic video display,

a play of the first game including a plurality of randomly selected game symbols arranged in a plurality of reels, one or more of the configurations of the randomly selected game symbols arranged along a payline being associated with a game outcome, the game outcome being associated with a value award payable to a player;

to display a set of two or more awards on the electronic video display contemporaneous with and separate from the first game,

each award in the set associated with a trigger event displayed as part of the first game, wherein if the trigger event occurs, the award is provided to the player,

each award in the set displayed in a queue starting with a present award according to when a determination will be made whether the trigger event associated with each award has occurred during a play of the first game;

to index to a subsequent award in the set and display the index to the subsequent award on the electronic video display after each play of the first game; and

to remove the present award from the set and add a new award to the set after the determination is made whether the trigger event associated with the present jackpot has occurred in the first game, and to remove an award from the set and add a new award to the set after each subsequent play of the first game.

Another embodiment provides a gaming machine comprising:

at least one display;

a value input comprising at least one of a coin acceptor, a bill acceptor and a ticket reader; and

at least one electronic controller coupled to the at least one display and the value input, the at least one controller configured:

to determine if a wager has been received via the value input;

to display a first game on the at least one display including one or more configurations of game symbols if a wager has been received, one or more of the configurations of game symbols being associated with a game outcome, the game outcome being associated with a value award payable to a player;

to display a set of two or more awards on the at least one display separate from the first game,

each award in the set associated with a trigger event, wherein if the trigger event occurs, the award is provided to the player,

each award in the set displayed in a queue from a lowest order award to a highest order award in the set according to when a determination will be made whether the trigger event associated with each award has occurred;

to index to a subsequent award in the set and display the index to the subsequent award each time a determination is made whether the trigger event associated with a previous award has occurred; and

to change the displayed set at least when the determination is made whether the trigger event associated with the highest order award in the displayed set has occurred.

Yet another embodiment provides a gaming machine comprising:

at least one electronic video display;

a value input comprising at least one of a coin acceptor, a bill acceptor and a ticket reader; and

at least one electronic controller coupled to the at least one electronic video display and the value input, the at least one controller configured:

to determine if a wager has been received via the value input;

to display a first game on the at least one electronic video display if a wager has been received,

a play of the first game including a plurality of randomly selected game symbols arranged in a plurality of reels, one or more of the configurations of the randomly selected game symbols arranged along a payline being associated with a game outcome, the game outcome being associated with a value award payable to a player;

to display a set of two or more awards on the electronic video display contemporaneous with and separate from the first game,

each award in the set associated with a trigger event displayed as part of the first game, wherein if the trigger event occurs, the award is provided to the player,

each award in the set displayed in a queue starting with a present award according to when a determination will be made whether the trigger event associated with each award has occurred during a play of the first game;

to index to a subsequent award in the set and display the index to the subsequent award on the electronic video display after each play of the first game; and

to remove the present award from the set and add a new award to the set after the determination is made whether the trigger event associated with the present jackpot has occurred in the first game, and to remove an award from the set and add a new award to the set after each subsequent play of the first game.

A further embodiment provides a method comprising:

displaying a first game including one or more configurations of game symbols, one or more of the configurations of game symbols being associated with a game outcome, the game outcome being associated with a value award payable to a player;

displaying a set of two or more awards separate from the first game,

each award in the set associated with a trigger event, wherein if the trigger event occurs, the award is provided to the player,

each award in the set displayed in a queue from a lowest order award to a highest order award in the set according to when a determination will be made whether the trigger event associated with each award has occurred;

indexing to a subsequent award in the set and displaying the index to the subsequent award each time a determination is made whether the trigger event associated with a previous award has occurred; and

changing the displayed set at least when the determination is made whether the trigger event associated with the highest order award in the displayed set has occurred.

A still further embodiment provides a method comprising:

displaying a first game,

a play of the first game including a plurality of randomly selected game symbols arranged in a plurality of reels, one or more of the configurations of the randomly selected game symbols arranged along a payline being associated with a game outcome, the game outcome being associated with a value award payable to a player;

displaying a set of two or more awards contemporaneous with and separate from the first game,

each award in the set associated with a trigger event displayed as part of the first game, wherein if the trigger event occurs, the award is provided to the player,

each award in the set displayed in a queue starting with a present award according to when a determination will be made whether the trigger event associated with each award has occurred during a play of the first game;

indexing to a subsequent award in the set and displaying the index to the subsequent award on the electronic video display after each play of the first game; and

removing the present award from the set and adding a new award to the set after the determination is made whether the trigger event associated with the present jackpot has occurred in the first game, and removing an award from the set and adding a new award to the set after each subsequent play of the first game.

An additional embodiment provides a method comprising:

determining if a wager has been received via a value input comprising at least one of a coin acceptor, a bill acceptor and a ticket reader;

displaying a first game including one or more configurations of game symbols if a wager has been received, one or more of the configurations of game symbols being associated with a game outcome, the game outcome being associated with a value award payable to a player;

displaying a set of two or more awards separate from the first game,

each award in the set associated with a trigger event, wherein if the trigger event occurs, the award is provided to the player,

each award in the set displayed in a queue from a lowest order award to a highest order award in the set according to when a determination will be made whether the trigger event associated with each award has occurred;

indexing to a subsequent award in the set and displaying the index to the subsequent award each time a determination is made whether the trigger event associated with a previous award has occurred; and

changing the displayed set at least when the determination is made whether the trigger event associated with the highest order award in the displayed set has occurred.

Yet another embodiment provides a method comprising:

determining if a wager has been received via a value input comprising at least one of a coin acceptor, a bill acceptor and a ticket reader;

displaying a first game if a wager has been received,

a play of the first game including a plurality of randomly selected game symbols arranged in a plurality of reels, one or more of the configurations of the randomly selected game symbols arranged along a payline being associated with a game outcome, the game outcome being associated with a value award payable to a player;

displaying a set of two or more awards on the electronic video display contemporaneous with and separate from the first game,

each award in the set associated with a trigger event displayed as part of the first game, wherein if the trigger event occurs, the award is provided to the player,

each award in the set displayed in a queue starting with a present award according to when a determination will be made whether the trigger event associated with each award has occurred during a play of the first game;

indexing to a subsequent award in the set and displaying the index to the subsequent award on the electronic video display after each play of the first game; and

removing the present award from the set and adding a new award to the set after the determination is made whether the trigger event associated with the present jackpot has occurred in the first game, and removing an award from the set and adding a new award to the set after each subsequent play of the first game.

A further embodiment provides a computer system comprising a central processing unit configured for communication with a gaming machine, wherein said computer system is configured to perform the method of any one of the above described embodiments.

A further embodiment provides a computer program configured to perform the method of any one of the above described embodiments.

A further embodiment provides a non-transitory carrier medium carrying computer executable code that, when executed on a central processing unit configured for communication with a gaming machine, causes the central processing unit to perform the method of any one of the above described embodiments.

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

Furthermore, as used herein and unless otherwise specified, the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

### BRIEF DESCRIPTION OF THE DRAWINGS

The disclosure will be more fully understood from the following description taken in conjunction with the accompanying drawings. Some of the figures may have been simplified by the omission of selected elements for the purpose of more clearly showing other elements. Such omissions of elements in some figures are not necessarily indicative of the presence or absence of particular elements in any of the exemplary embodiments, except as may be explicitly delineated in the corresponding written description. None of the drawings is necessarily to scale.

FIG. 1 is a perspective view of a gaming machine according to an embodiment of the present disclosure;

FIG. 2 is a block diagram of the components of the embodiment of the gaming machine of FIG. 1;

FIG. 3 is a simulated screenshot of a game played on the gaming machine of FIG. 1;

FIG. 4 is a simulated screenshot of the game played on the gaming machine of FIG. 1 after a first play or spin, with a set of awards arranged in a dynamic, indexed queue also displayed on the display at the same time;

FIG. 5 is a simulated screenshot of the game played on the gaming machine of FIG. 1 after a second play and with the set of awards having been indexed;

FIG. 6 is a simulated screenshot an alternative embodiment of the set of awards arranged in a dynamic, indexed queue;

FIGS. 7-9 are simulated screenshots of the game played on the gaming machine of FIG. 1 after a third and fourth play and before a fifth play, with the set of awards having been indexed after each of the second, third, and fourth plays;

FIGS. 10 and 11 are simulated screenshots of a further alternative embodiment of the set of awards indexed in a different fashion than the sets of FIGS. 4, 5, and 7-9.

FIG. 12 is a simulated screenshot of an embodiment of a set of awards displayed on a circular array in the form of a wheel;

FIG. 13 is a simulated screenshot of an embodiment of a set of awards displayed on a circular array in the form of a reel;

FIG. 14 is a simulated screenshot of another embodiment of a set of awards arranged in an indexed queue;

FIGS. 15 and 16 are simulated screenshots of an embodiment of set of awards where the entire set is replaced after the determination is made whether the last award in the set of FIG. 15 is to be provided;

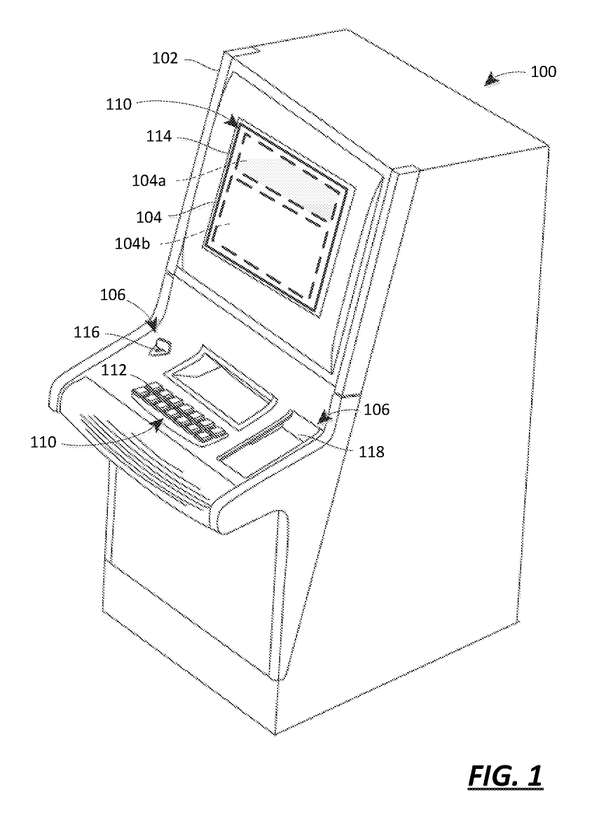

FIGS. 1 7 and 18 are simulated screenshots of an embodiment of a set of awards where multiple instances of a single award are removed and replaced;

FIG. 19 is a simulated screenshot of an embodiment of the game played on the gaming machine of FIG. 1 with a plurality of dynamic, indexed queues; and

FIG. 20 is a simulated screenshot of an embodiment including a plurality of dynamic, indexed queues where multiple instances of a single award in different queues are removed and replaced;

FIG. 21 is a perspective view of an electronic gaming machine according to yet another embodiment;

FIG. 22 is a block diagram of the electronic components of the electronic gaming machine of FIG. 21.

### DETAILED DESCRIPTION OF VARIOUS EMBODIMENTS

The present invention will now be described with reference to the following examples that should be considered in all respects as illustrative and non-restrictive.

In general terms, a gaming machine according to the embodiments described herein includes at least one display, a value input, and an electronic game controller coupled to the at least one display and the value input.

The game controller is configured to determine if a wager has been received via the value input, and to display a first game on the at least one display if a wager has been received. The first game includes one or more configurations of game symbols, one or more of the configurations of game symbols being associated with a game outcome, the game outcome being associated with a value award payable to a player.

The game controller is also configured to display a set of two or more awards on the at least one display separate from the first game. Each award in the set is associated with a trigger event, wherein if the trigger event occurs, the award is provided to the player. Each award in the set is displayed in a queue from a lowest order award to a highest order award in the set according to when a determination will be made whether the trigger event associated with each award has occurred.

The game controller is further configured to index to a subsequent award in the set and display the index to the subsequent award each time a determination is made whether the trigger event associated with a previous award has occurred, and to change the displayed set at least when the determination is made whether the trigger event associated with the highest order award in the displayed set has occurred.

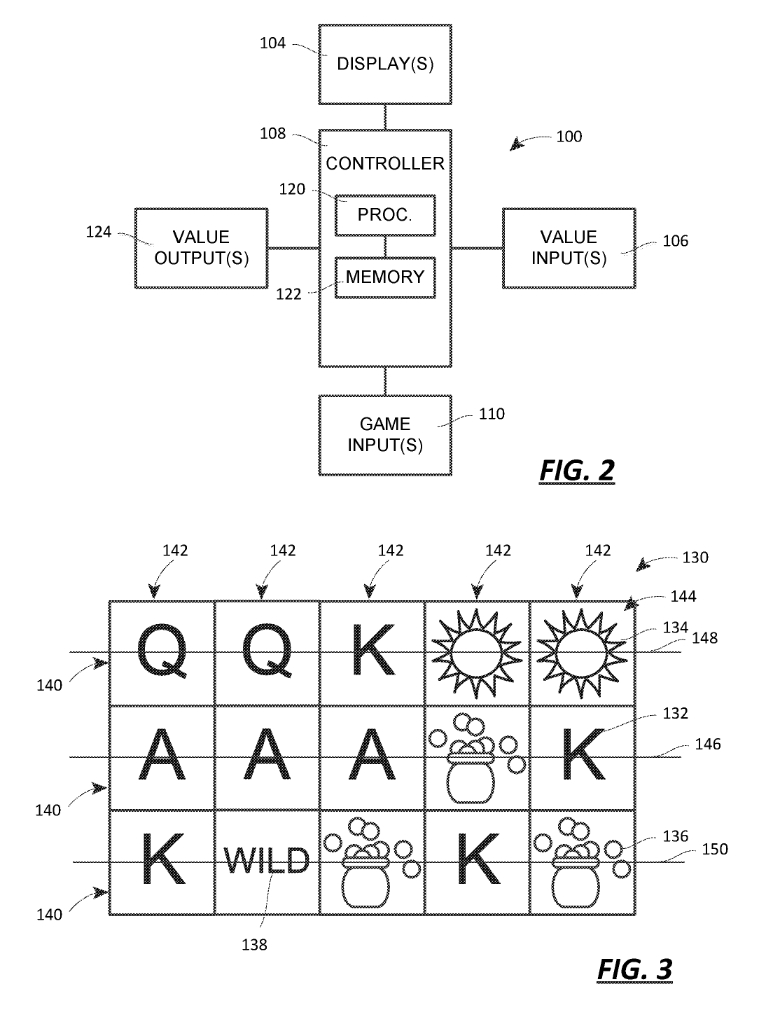

With reference now to FIG. 1, the gaming machine 100 may include a housing (or cabinet) 102 in which the at least one display 104 is mounted. With reference to FIGS. 1 and 2, the value input 106 and electronic controller 108 (see FIG. 2) may be mounted on or disposed within the housing 102. For example, the value input 106 may be mounted on the housing 102 such that at least part of the value input 106 is accessible by the player, while the electronic controller 108 is disposed (and secured) within the housing 102. A game input device 110, in the form of a set of buttons 112 or a touchscreen 114 as illustrated in FIG. 1, may be mounted on the housing 102 and accessible by the player to provide inputs to the electronic controller 108.

The at least one display 104 may be an electronic display, for example an electronic video display, such as a LED display or a plasma display as is illustrated in FIG. 1. Both the first game and the set of awards may be displayed on the same display 104, but in different sections 104a, 104b of the display area of the display 106, as illustrated in FIG. 1. According to other embodiments, separate displays may be used. In fact, according to certain embodiments, the at least one display may include a mechanical, electromechanical or electronic display for use in displaying the first game and a separate mechanical, electromechanical or electronic display for the set of awards.

According to certain embodiments, the value input 106 may be at least one of a coin acceptor, a bill acceptor and a ticket reader. According to certain embodiments, the value input 106 may include a coin acceptor, a bill acceptor and a ticket reader. For that matter, as illustrated, the value input 106 may include a coin acceptor 116 and a bill acceptor 118 that may function as a ticket reader as well, such that the value input 106 may be considered to include a bill acceptor and a ticket reader.

In a general sense, the value input 106 may be configured to receive value, such as cash in the form of banknotes and coins, or credits representing a monetary amount from a memory device, such as but not limited to a memory card, smart card, a radio frequency identification (RFID) device, USB key, magnetic card or other electronic storage device. Typically, the memory device is a credit card, debit card or other card that enables the transfer of monetary credit to the gaming machine 100. Other forms of value include gaming tokens, paper, tickets, vouchers, and any other object representative of value.

As illustrated in FIG. 2, the electronic game controller 108 may include a microprocessor 120 (which, in fact may include multiple physical and/or virtual processors). According to other embodiments, the controller 108 may include one or more electrical circuits designed to carry out the actions described herein. In fact, the controller may include a microprocessor 120 and other circuits or circuitry. In addition, the controller may include one or more memories 122. The instructions by which the microprocessor 120 is programmed may be stored on the memory 122 associated with the microprocessor 120, which memory/memories 122 may include one or more tangible non-transitory computer readable memories, having computer executable instructions stored thereon, which when executed by the microprocessor 120, may cause the microprocessors 120 to carry out one or more actions as described below.

The controller 108 may be directly or indirectly coupled to the display(s) 104, value input(s) 106, and game input(s) 110 mentioned above. The controller 108 may also be directly or indirectly coupled to one or more value output(s) 124, as indicated in FIG. 2. For example, the value output 124 may be coin or bill dispenser or a ticket writer.

As mentioned above, the game includes one or more configurations of game symbols, one or more of the configurations or combinations of game symbols being associated with a game outcome, the game outcome being associated with a value award payable to a player. According to certain embodiments, the game may be primary game, although the game may alternatively be a bonus game or event. For that matter, a trigger event that occurs in or during play of the game may lead to a second game, which may be a bonus game or event.

According to certain embodiments, the game symbols may be used to play a slots-type game. According to other embodiments, the game symbols may be used to play a poker-type game. According to still other embodiments, the game symbols may be used to play a bingo or keno-type game.

According to certain embodiments, the game symbols are organized into three rows and five columns (a 5×3 array). Other arrays, such as a 3×3 or 4×3, may be used in the alternative. The electronic controller 108 may randomly select the game symbols that appear in or on the array (e.g., using a random number generator, which may be incorporated into the machine 100, for example in the electronic controller 108), each column of the array corresponding to a reel in a mechanical or electromechanical display, and provide an award based on the randomly selected configuration. Alternatively, the machine 100 (or a server associated with the machine 100) may select an outcome from a pool of outcomes, and the machine 100 may display a configuration of symbols in accordance with that outcome, and provide an award in accordance with the outcome.

According to an embodiment illustrated in FIG. 3, play of the first game 130 includes generation of a plurality of randomly selected game symbols 132, 134, 136, 138, which symbols 132, 134, 136, 138 are arranged in a plurality of rows 140 and columns 142, which columns 142 may each correspond to a reel in a mechanical or electromechanical display. The rows 140 and columns 142 may define an array 144.

Each of the game symbols 132, 134, 136, 138 is disposed in a game position. As illustrated, the game positions are demarked with a solid border or boundary line. According to other embodiments, the boundary lines between game symbols in the same column 142 may be not be visible or there may be no boundaries. It is also possible for the boundary lines between game symbols in game positions along a row 140 to be omitted or not visible.

The game symbols 132, 134, 136, 138 are non-limiting examples of game symbols that may be present in a play of the game of the illustrated embodiment. For example, the game symbols may represent card ranks (or ordinal values) 132 or objects 134. The game symbols may also include those symbols 136 used to determining if a separate award, such as progressive jackpot, is to be awarded. Further game symbols may be WILD symbols 138, which may be used in place of the game symbols 132, 134 when determining if a winning combination of game symbols is present.

In particular, winning combinations of game symbols may be determined according to the game symbols arranged along a payline 146, 148, 150, winning combinations of game symbols associated with a value award provided to the player. While three exemplary paylines 146, 148, 150 are illustrated in FIG. 3, it will be recognized that additional paylines may be includes in other embodiments. Further, it is conventional that only game symbols 132, 134, 136, 138 arranged along an active payline (one on which the player has made a wager) will be considered. For example, an arrangement of three or more instances of the same game symbol on an active payline (e.g., the three instances of “A” on the payline 146) may result in a value award, with different game symbols resulting in lower or higher value awards.

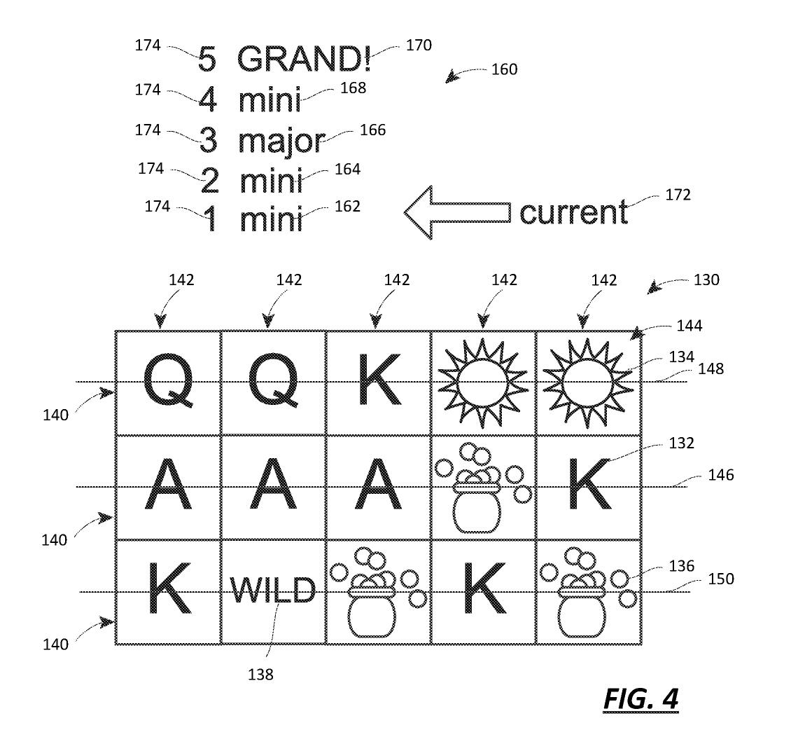

As mentioned above and with reference to FIG. 4, the game controller 108 is also configured to display a set 160 of two or more awards 162, 164, 166, 168, 170 on the at least one display 104 separate from the first game. Each award 162, 164, 166, 168, 170 in the set 160 is associated with a trigger event, wherein if the trigger event occurs, the award is provided to the player. Each award 162, 164, 166, 168, 170 in the set 160 is displayed in a queue from a lowest order award 162 to a highest order award 170 in the set 160 according to when a determination will be made whether the trigger event associated with each award has occurred.

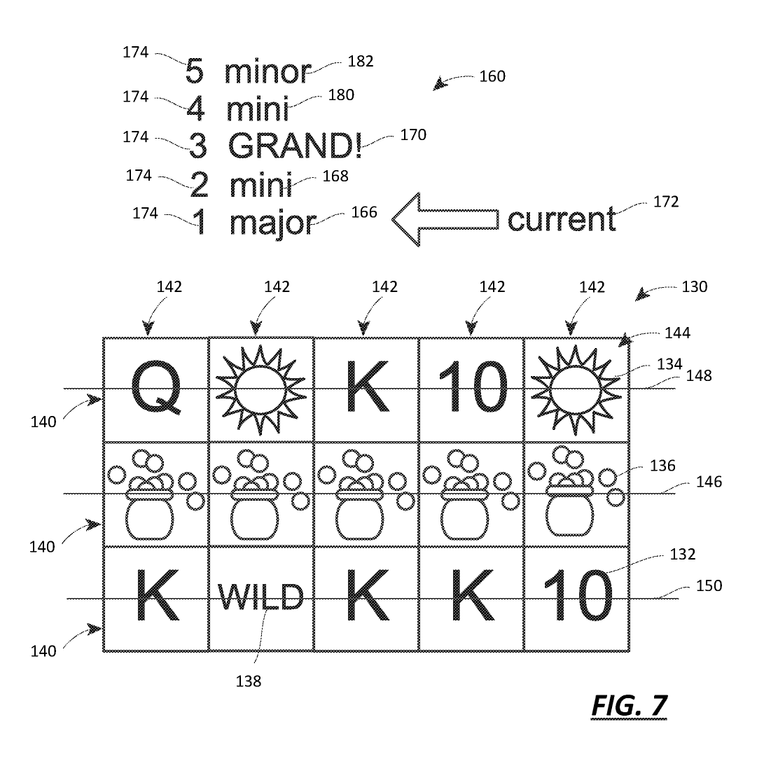

For example, the awards 162, 164, 166, 168, 170 may be progressive jackpots, and each individual instance of award 162, 164, 166, 168, 170 is selected from the group comprising a mini progressive jackpot, a minor progressive jackpot, a major progressive jackpot, and a GRAND! progressive jackpot. Each of the jackpots may be awarded if five special game symbols associated with the progressive jackpots appears along a payline in the first game. For example, the special game symbol may be a pot of gold 136, and the appearance of five pots of gold 136 along any active payline 146, 148, 150 may result in a progressive jackpot win (see FIG. 7).

It is not necessary that the trigger event occur in the game 130, however. The trigger event may occur instead during play of the game 130, but not in the game 130—e.g., a separate random determination is made during each play as to whether the present award (e.g., award 162) is to be provided to the player. Nor is it a requirement of all of the embodiments described herein that the trigger event occur in the game 130 or during the play of the game 130—it may be sufficient that the player is at the machine 100 at the correct time of day, the determination being made a periodic increments of time whether the correct time has occurred.

It is also not necessary that the same trigger event be used in the determination for each instance or award 162, 164, 166, 168, 170 present in the queue. For example, a queue may include awards for which an arrangement of special game symbols (e.g., symbol 136) along an active payline (e.g., 146, 148, 150) in the first game 130 is the trigger event. For other awards in the same queue, the trigger event may be simply the occurrence of two or more special symbols in the first game 130 (e.g., where the special symbols are scatter symbols that may appear anywhere, not necessarily on an active payline, such as paylines 146, 148, or 150). For still other awards, the trigger event may be determined according to a randomly generated number. Consequently, it is possible for a single trigger event to be used for the determination of all awards, but it is not a necessary requirement for all disclosed embodiments herein.

As mentioned above, the instances of awards (e.g., progressive jackpots in the embodiment illustrated in FIG. 4) are arranged in a queue, or ordered arrangement. Specifically, the awards 162, 164, 166, 168, 170 are arranged chronologically from the bottom of the queue to the top of the queue in the order in which the controller 108 will determine if the jackpot has been won. In such a circumstance, the instance of whatever jackpot will be determined based on the current or present play of the first game will be listed in the lowest order in the list (e.g., the first position 162). On the other hand, the instance of the jackpot which will be determined based on the play of the game furthest in the future (e.g., the jackpot to be determined last in a queue of five jackpots) will be the highest order in the list (i.e., the fifth position 170 in the embodiment illustrated in FIG. 4).

As a consequence of the display of the current award 162 and the future awards 164, 166, 168, 170, the player can determine whether a determination of the winning condition for that award will occur in the near future or the far future. Furthermore, the player may derive other visual cues from the queue, such as whether a large number of smaller awards or larger awards are going to be determined presently and in the near or far future on the machine 100. Such information may be used by the player in determining whether to continue playing the machine 100.

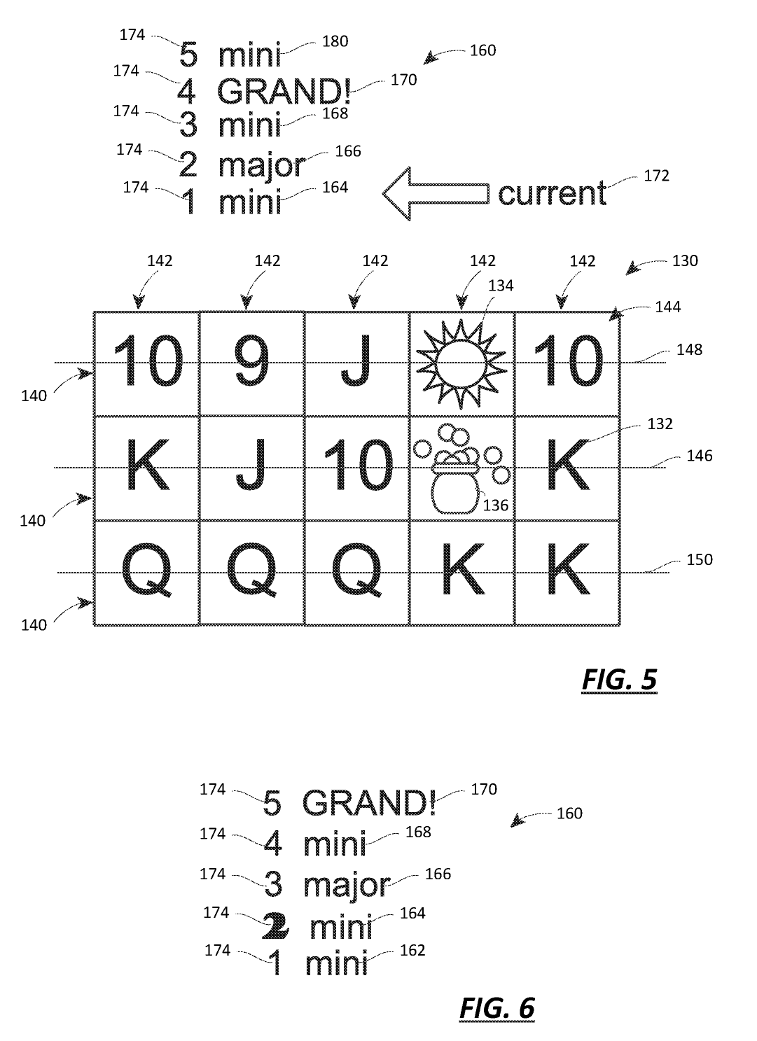

To assist the player in understanding the information conveyed by the queue, the queue may also include an indicator 172, 174. The indicator 172 may be displayed aligned with the lowest order award (e.g., 162) in the queue prior to indexing, and aligned with a second award (e.g., 164) in the queue after indexing (see FIG. 5). The change in the alignment of the indicator 172 may be cause by movement of the indicator 172 relative to the queue, by movement of the queue relative to the indicator 172, or by motion of the indicator 172 and the queue relative to each other.

it is also possible that the indicator need not move from one award to the next. For example, the indicator 174 may take the form of a number associated with each of the awards 162, 164, 166, 168, 170. The awards 162, 164, 166, 168, 170 may be numbered from the award under present or current consideration (e.g., 162) to the futuremost award (e.g., 170) in the set 160. For example, the present award 162 may be numbered “1”, the subsequent award “2”, the next subsequent award “3” and so on. As the controller 108 indexes through the queue, a different number may be illuminated to indicate to the player which award is presently under consideration (see the indicator associated with the award 164 in FIG. 6). For that matter, the queue in the form of a list may move past the numbers (see FIG. 5), to indicate which award in the list is the award under present consideration.

FIGS. 5 and 7-9 illustrated a series of consecutive operations of a machine 100 according to an embodiment of the present disclosure taken relative to the state illustrated in FIG. 4.

FIG. 4 illustrates a first state of the machine 100 according to a first play, or spin, of the game 130. The machine 100 is configured to determine if a wager has been received via the value input 106, and to display the game 130 on the at least one display if a wager has been received. In this play, the configuration of game symbols 132, 134, 136, 138 is as shown. Furthermore, the set 160 of awards includes a first instance of a mini jackpot 162, a second instance of a mini jackpot 164, a major jackpot 166, a third instance of a mini jackpot 168 and a GRAND! jackpot 170. The indicators 172, 174 identify the award/jackpot 162 as the current award/jackpot under consideration. The indicators 174 also indicate the relative positions of the remaining future jackpots 164, 166, 168, 170 in the queue.

According to the configuration of game symbols 132, 134, 136, 138 illustrated, the controller 108 would determine that a value award should be provided for the three “A” game symbols 132 arranged along the payline 146. As none of the other paylines 148, 150 have more than two game elements in a row (considering each row 140 from left to right), no other value awards are payable for the configuration of game symbols shown in FIG. 4. In addition, the controller 108 determines whether any of the paylines 146, 148, 150 include five game symbols 136, the trigger event for payment of the present or current award in the set 160. Because none of the paylines 146, 148, 150 include the five game symbols 136, the award 162 is not provided to the player.

After the controller 108 determines that the trigger event did not occur in the first play of the game 130, the controller 108 indexes the awards as illustrated in FIG. 5. In particular, the mini jackpot 164 becomes the new present or current award. This is visible to the player as a consequence of the alignment of the indicator 172 with the award 164, as well has a change in the number used for the indicator 174 associated with the award 164.

According to this embodiment of the present disclosure, the controller 108 also modifies the awards in the set 160. In particular, the award 162 is removed from the queue, and a new award 180 (a third instance of the mini jackpot) is added to queue. The newly added award 180 is also associated with an indicator 174 corresponding to “5” so that the player knows that the award 180 is the futuremost event in the queue.

FIG. 5 also illustrates a new configuration of game symbols 132, 134, 136 corresponding to a second play of the game 130. According to this play, there are three “Q” game symbols 132 and two “K” game symbols 132 along the payline 150, which results in a value award to the player as part of the second play of the game 130. On the other hand, neither the configuration of game symbols along the payline 146 nor that along the payline 148 would result in a value payout. Furthermore, because there is only one game symbol 136 shown, the controller 108 determines that the trigger event for payment of the mini jackpot 164 has not occurred.

After the determination is made that the trigger event for the award 164 has not occurred in the second play of the game 130, the controller 108 indexes the set 160 to the state illustrated in FIG. 7. in particular, the indicators 172, 174 indicate that the major jackpot 166 is the current award or jackpot under consideration. Further, the mini jackpot 164 has been removed from the queue, and a further new jackpot 182 (a minor jackpot) has been added to the queue.

FIG. 7 illustrates a third play of the game 130, with a still further configuration of game symbols 132, 134, 136. 138. According to this play of the game 130, the controller 108 determines that a value award should be provided to the player for the arrangement of game symbols 132, 138 along the payline 150. In this regard, the controller 108 considers the WILD game symbol 138 to be a “K” game symbol 132, and thus determines that there is a combination of four “K” game symbols along the payline 150.

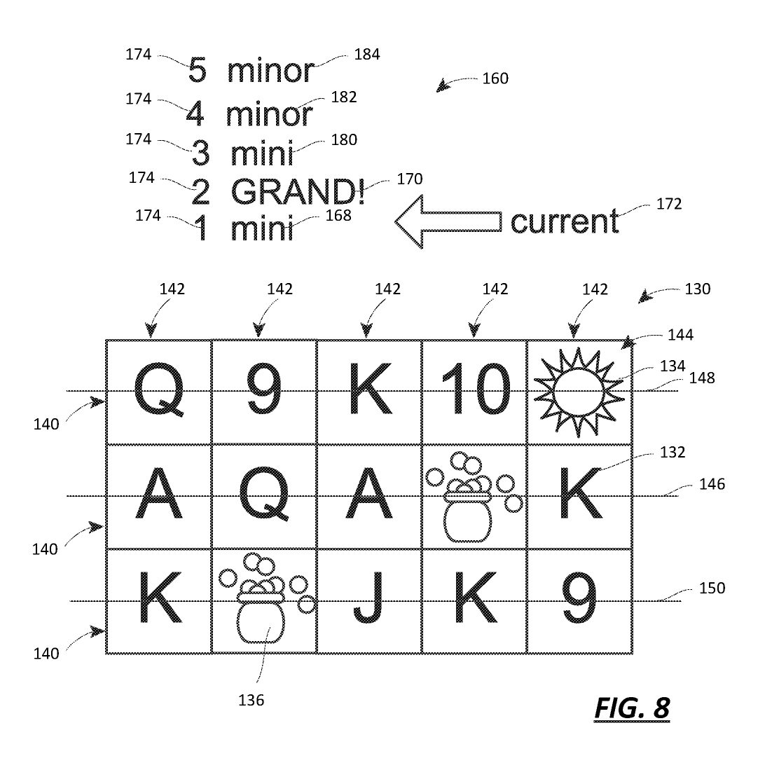

In addition, the controller 108 determines that there are five game symbols 136 arranged along the payline 146. As a consequence, the controller 108 also determines that the major jackpot should be provided to the player because the major jackpot 166 is the current award in the queue. Once the award has been paid to the player, the machine 100 continues to the state illustrated in FIG. 8.

Again, the controller 108 causes the queue to index, such that the mini jackpot 168 is the current award. Further, the award 166 is removed from the set 160, and a new award 184 (second instance of a minor jackpot) is added to the queue.

FIG. 8 also illustrates a configuration of game symbols 132, 134, 136 that define a fourth play of the game. According to this configuration, the controller 108 would determine that there are no configurations of game symbols 132, 134 that would result in a value award being provided to the player. Furthermore, the controller 108 would determine that the trigger event for award 168 is also not present in the fourth play of the game.

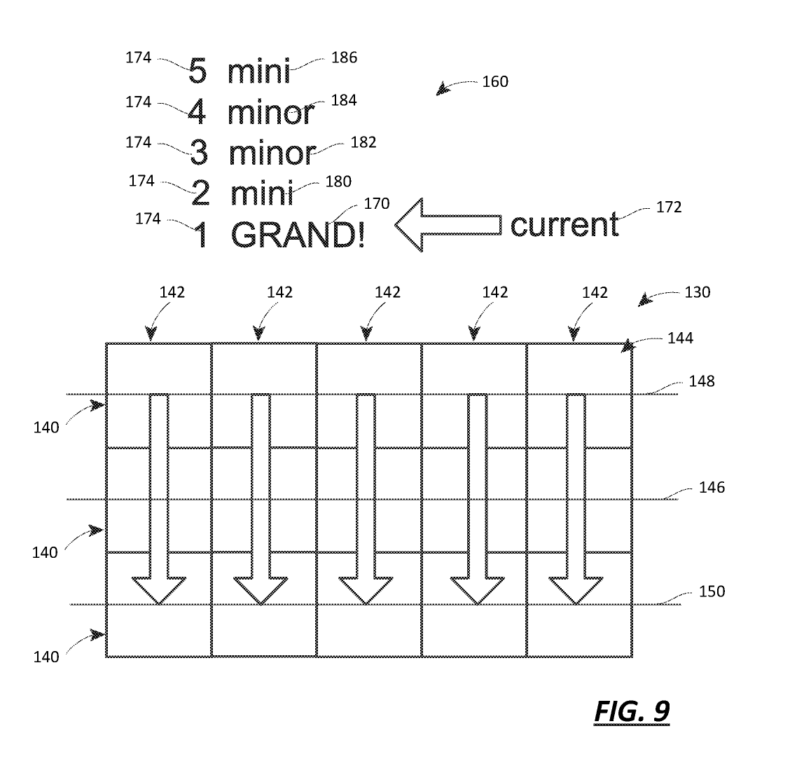

FIG. 9 illustrates a state of the machine 100 subsequent to the fourth play of the game 130, but before the game symbols are visible in the array 144. As can be seen, the controller 108 has indexed the awards, such that the GRAND! jackpot 170 is now the current jackpot. Furthermore, the award 168 has been removed from the queue, and new award 186 (a second instance of a mini jackpot) has been added to the queue. Because the game symbols are not yet visible, a placeholder image may be disposed in the array 144 in their place: for example, the placeholder image may be of a downward arrow as illustrated, or the image may be of a blurred image of the game symbols as if they were in movement in a downward direction in the columns 142.

Additional plays of the game 130 may involve further determinations whether a winning combination of game symbols has occurred along one of the active paylines, and whether a trigger event (also a combination of game symbols according to the present embodiment) has occurred to cause the present award from the set 160 of the awards to be provided to the player.

While the embodiment of FIGS. 4, 5 and 7-9 includes indexing of the awards in the queue after every play of the game 130, the indexing may occur in response to other events instead. For example, the indexing may occur only after a successful determination, as in FIG. 7. Alternatively, the indexing may occur when at least one game symbol, such as the progressive game symbol 136, is present in the game 130. If such an embodiment was implemented relative to the configurations illustrated in FIGS. 4, 5, 7, and 8, the queue would still be indexed after the first through fourth play because at least one progressive game symbol 136 was present in each of the arrays 144 for each of these plays.

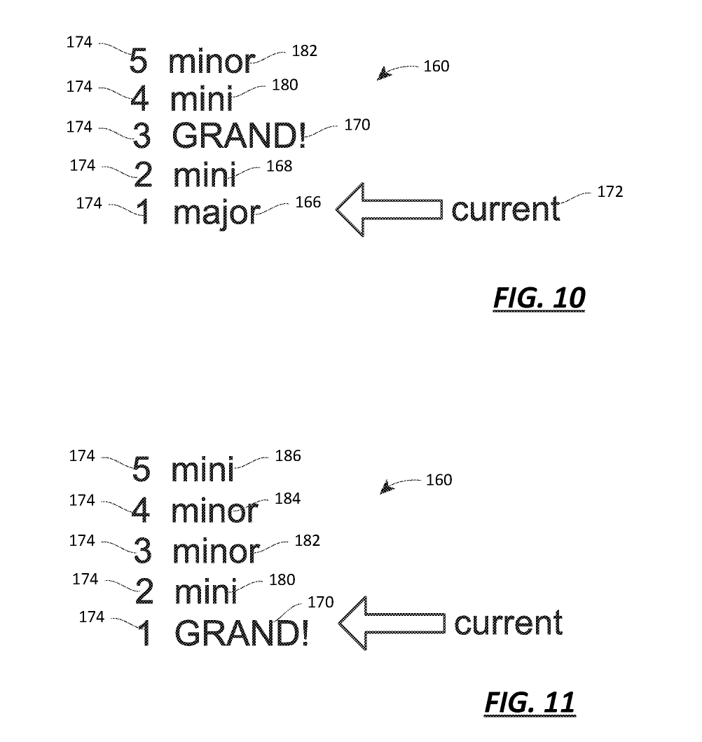

According to certain embodiments, such as those illustrated in FIGS. 4, 5, and 7-9, the indexing from previous award to subsequent award occurs between awards that are adjacent in the queue (e.g., awards 162, 164 in FIGS. 4 and 5). That is, with the awards of the list arranged 162, 164, 166, 168, 170, the indexing would go from award 162 to award 164, from award 164 to award 166 and so forth. However, according to other embodiments, the subsequent award and the previous award are not adjacent in the queue. As illustrated in FIGS. 10 and 11 relative to FIG. 4, the indexing may go from award 162 to award 166 for the second play of the game 130, then from award 166 to award 170 for the third play of the game 130, and so on (i.e., every two awards, skipping over the intermediate, adjacent award). For that matter, the indexing may be every third, fourth, etc. award, or may occur according to a number of awards where the number is randomly selected, for example.

As a further alternative, an embodiment may include indexing where the indexing may proceed from one award to the adjacent award through part of the queue, and from one award to a non-adjacent award through another part of the queue. For example, consider an embodiment where the queue is indexed as between that illustrated in FIGS. 4 and 5 between the first and second plays of the game, and between that illustrated in FIGS. 5 and 11 between the second and third plays of the game.

According to certain embodiments, the rate of indexing through the queue may be determined whether a second trigger (e.g., a combination of game symbols along an active payline) is present in or during the first game. If the second trigger is not present, then the indexing may be between adjacent awards for example. If the second trigger is present, then the indexing may be between non-adjacent awards, with the size of the index (e.g., two awards) being determined by one of a variety of methods. For example, the size of the index may be selected randomly, or may be a fixed amount (e.g., two, three, etc.) each time the second trigger occurs.

As a further example, the rate of indexing may vary according to the size of the wager made by the user on the first game. Alternatively, the player may pay or wager to control the size of the indexing, although the player may still have no control over the outcome of the determination whether the award will be provided, that determination relying on a trigger occurring in or during the play of the game 130,

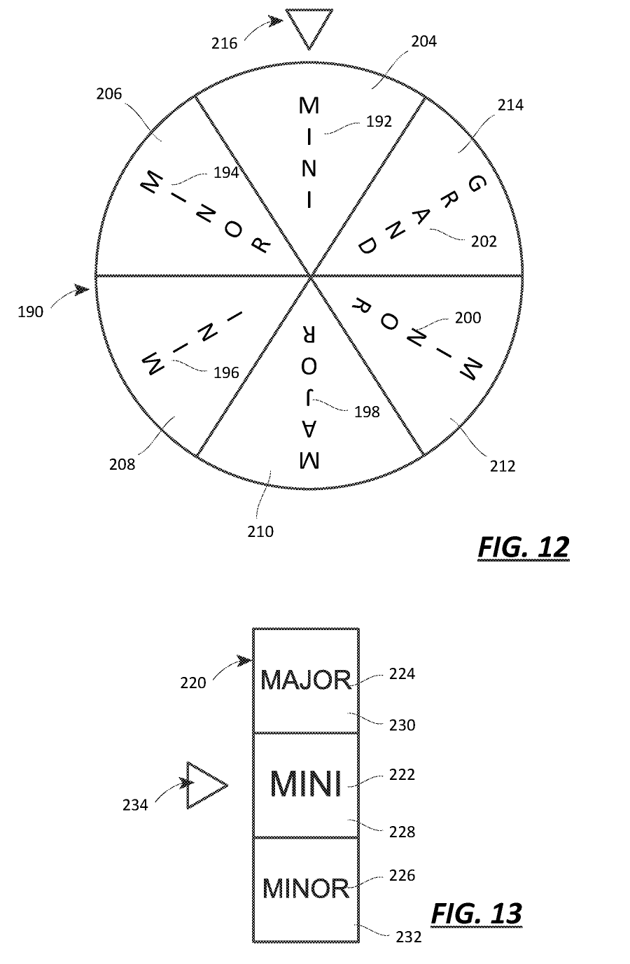

As illustrated in FIGS. 4-11, the queue comprises a linear list of the two or more awards. According to other embodiments, illustrated in FIGS. 12 and 13, the queue may include a circular list of the two or more awards. For example, in FIG. 12 the circular list may be displayed as a circular array 190 in the form of a wheel having clockwise motion, with one of the awards 192, 194, 196, 198, 200, 202 displayed in each segment 204, 206, 208, 210, 212, 214 of the wheel and the current award identified by an indicator 216. Alternatively, the circular list may be displayed as a circular array 220 in the form of a reel (viewed head on in FIG. 13 with rotation from top to bottom of the page), with one of the awards 222, 224, 226 displayed in each position 228, 230, 232 of the reel 220 and the current award identified by the indicator 234. According to the embodiment of FIG. 13, there may be multiple awards and positions between the award 226 and the award 224 and between the position 232 and the position 224, which awards and positions are not visible because they are arranged on the reverse side of the reel 220 from the side visible in FIG. 13. As such, the futuremost award 226 may be visible for a period of time, and then move into an orientation where the award 226 is not visible, until it again becomes visible at the top of the reel 220 as the controller 108 indexes through the awards in the queue.

It will be recognized that the same removal and addition of awards as was described above relative to a linear list may also occur with respect to a set of awards arranged in a circular list, as displayed in a circular display.

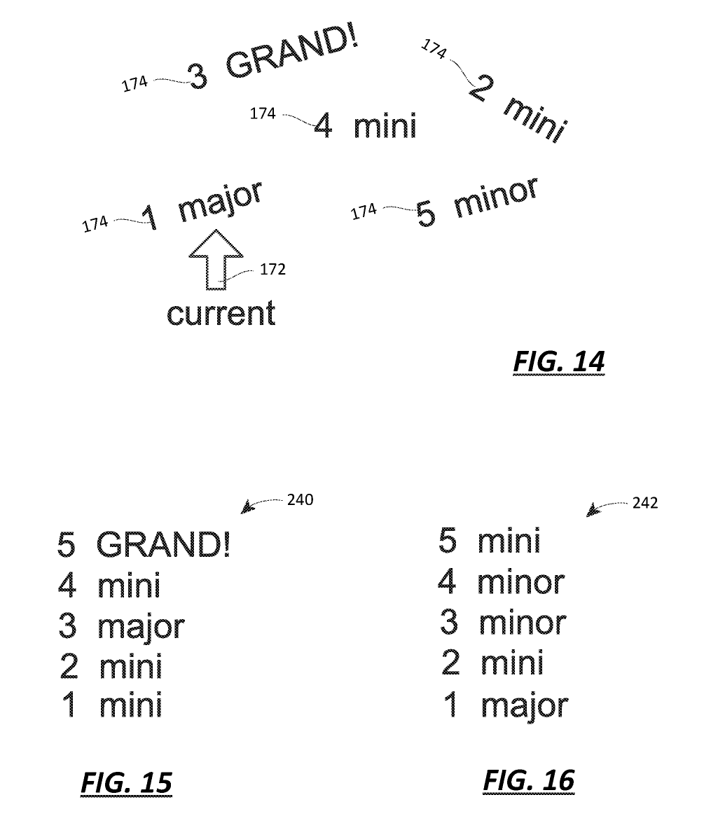

Other shapes may be incorporated into the display of the queue, such as stars or hexagons for example. The queue may even take the form of a seemingly disorganized arrangement of awards (see FIG. 14), the organization of which becomes apparent when the controller indexes through the awards or by the numerical identifier 174 associated with such awards, and optionally the identifier 172.

As was the case in regard to several of the illustrated embodiments above, multiple individual instances of an award appear in the queue (see, e.g., the three instances of the mini jackpot appearing in FIG. 4 or FIG. 5). For example, where the award is a progressive jackpot, the award may be selected from among four different progressive jackpots: a mini progressive jackpot, a minor progressive jackpot, a major progressive jackpot, and a GRAND! jackpot. If the set includes only four awards, it is possible to include each award/jackpot only once in the queue. If the set includes more than four awards, then one of the jackpots will be included more than once in the queue (e.g., the mini, mini, major, mini, GRAND! in the set 160 of five awards in FIG. 4).

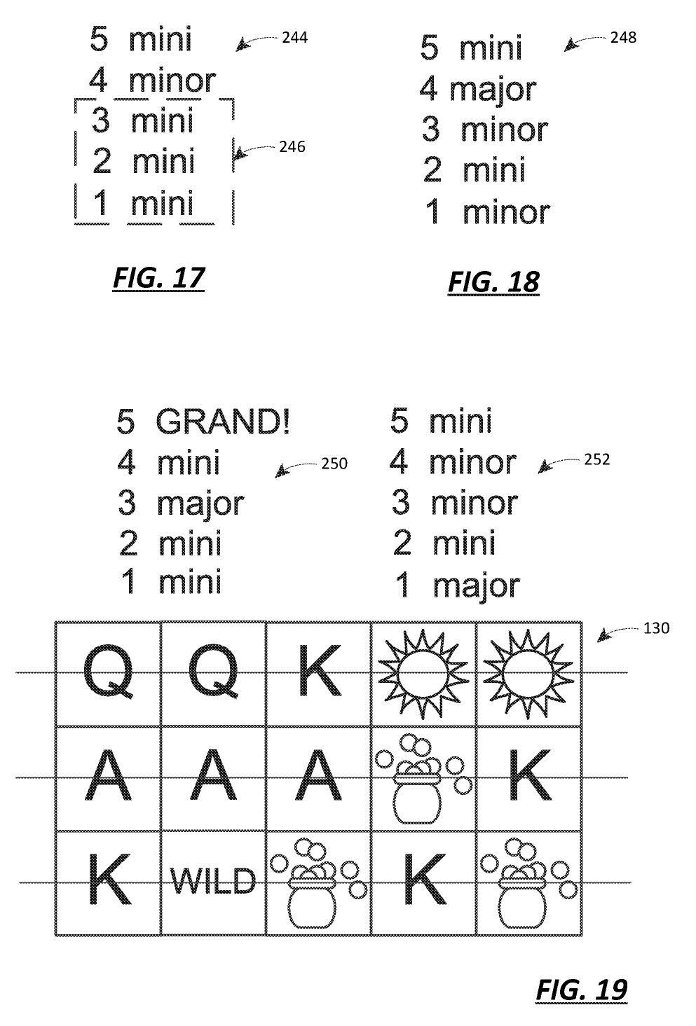

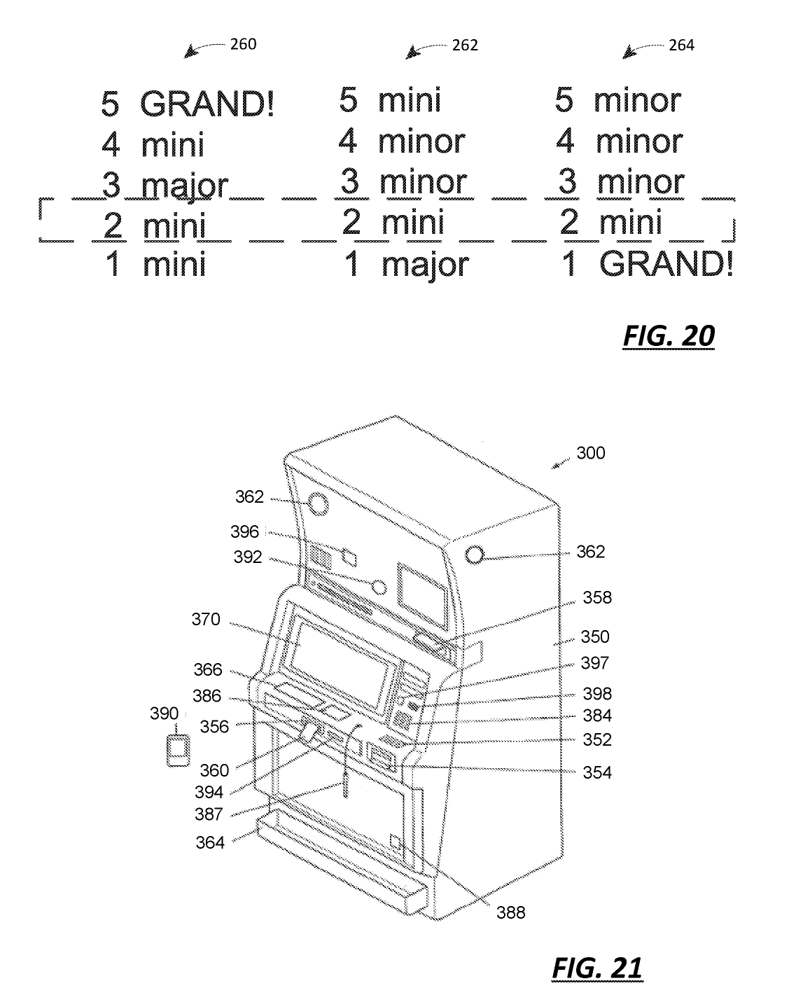

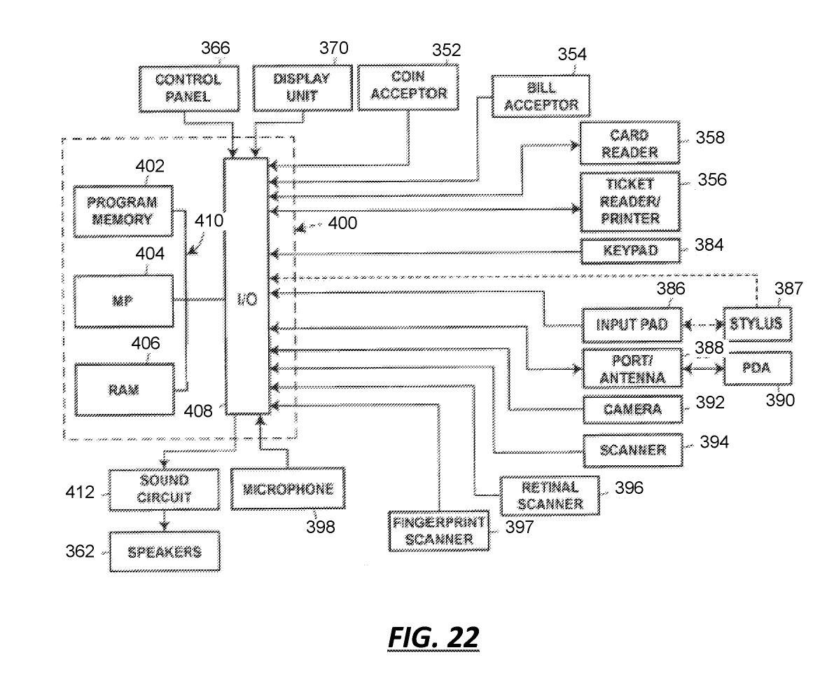

As mentioned above, the queue according to the illustrated embodiments is dynamic. That is, the queue does not remain the same for all time, but changes over time. For example, wherein the set of two or more awards is replaced with another set of two or more awards when the determination is made whether the trigger event associated with the highest order award in the displayed set has occurred (compare FIGS. 15 and 16, the replacement of set 240 with set 242 occurring after the determination is made as to the GRAND! jackpot in set 240). According to other embodiments, the lowest order award is removed from the queue after indexing, and another award is added to the queue after the highest order award (compare FIGS. 4 and 5). This may be used in conjunction with an indicator, above, to change the alignment of the indicator with the awards.

It is also possible for two or more awards to be removed from the queue, and two or more awards added to the queue to change the displayed set. This is particularly relevant where the list includes three or more awards. For example, the controller 108 may determine if a second trigger is present in or during the play of the first game 130. If the second trigger is present, the controller may remove two awards from the queue instead of the lowest order award and to add two new awards to the queue.

It may be possible that the second trigger occurs in the queue, rather than in the first game. For example, if a large enough number of instances of the same award are present adjacent to each other in the queue, these adjacent instances of the same award may be removed from the queue, and new instances of the awards may be added to the queue. For example, the set 244 in FIG. 17 includes three instances (246) of the mini jackpot award. All three of the instances may be removed, and the queue may “collapse” with the instance of the minor jackpot previously in fourth position in the set 244 illustrated in FIG. 17 being moved to the first (current) position in the set 248 illustrated in FIG. 18, the instance of the mini jackpot award previously in fifth positon being moved to the second position, and three new awards being added to the set 248. As an alternative, the multiple instances of the same award may be replaced with a single instance of the award, and new awards may be added to the queue to replace the removed multiple instances.

Furthermore, it is possible to have multiple queues displayed at the same time. See, for example, the embodiment illustrated in FIG. 19, wherein two sets 250, 252 of awards are displayed with the game 130. Each queue may operate independent of the others (e.g., when indexed, rate of indexing, etc.), and may each queue may provide different awards than the other queues. Alternatively, the queues may operate independently, but provide similar awards, or the queues may operate in a coordinated fashion (e.g., index based on the same trigger, same rate of indexing, etc.), but may provide different awards. It is also possible to have coordinated queues offering the same or similar awards. The difference in the awards may be as to type (e.g., jackpots vs. multipliers), the size of the awards (e.g., one has multipliers from 1× to 5×, a second has multipliers 6× to 10×, and so on) or as to the number instances of an award permitted (one queue may permit repeats while another does not).

According to one embodiment, it may be possible to coordinate the operation of the multiple queues in a fashion similar to that discussed above where multiple instances of the same award in a queue result in removal and replacement of the multiple instances. For example, three sets 260, 262, 264 are illustrated in FIG. 20. Each of the sets 260, 262, 264 includes an instance of the mini jackpot in the second position. According to the present embodiment, the three instances of the mini jackpot may be removed, the queues “collapsed” such that the major jackpot is now in the second position in the set 260, the minor jackpot is in the second position in the set 262, and the minor jackpot is in the second position in the set 264. Removal of multiple instances of the same award in different queues and addition of new awards may occur instead of or in addition to removal and replacement of multiple instances in a single queue (e.g., the three instances of the minor jackpot in set 264).

While the determination is made whether the present award is to be awarded to the player for each award in the list, it may be possible that a determination relative to the present award also permits the player to receive future awards displayed in the queue as well. For example, if a second trigger occurs in or during the play of the game, then the controller 108 may cause the player to receive the present award and one or more of the future awards. For example, the player may receive the present award and all of the future awards, where the awards are all different, or at least one instance of each of the future awards, where more than one instance of certain awards are present.

The player's ability to receive present and future awards during a determination as to the present award may depend on the amount wagered on the first game. Alternatively, a side wager or side bet may be required to access the opportunity for the controller to determine if the player will receive future awards as well as the present award.

While the indexed, dynamic queue has been described as part of a gaming machine, such as a slot machine, the queue may be operated apart from a slot machine. For example, at least one display and an electronic controller may be combined with a housing in the form of a bolt-on or top-box device that can be used with an existing gaming machine. According to such an embodiment, the controller of the bolt-on or top-box device may operate the associated display in accordance with the description provided above. The bolt-on or top box device may include an input to interface with an existing gaming machine, or another device.

For example, a bolt-on or top box device may be used in combination with an existing gaming machine, which includes its own display, value input, and controller. Alternatively, the bolt-on or top box device may be used in combination with a table game, the device having an input that may be used to receive results from the table game and use the results as part of the determination carried out relative to the awards in the queue. As a further alternative, the bolt-on or top box device may be used with a kiosk, such as may be used with a player loyalty club, with each swipe of the player triggering a random number generation that is used to determine if an award is provided to the player.

Referring to FIG. 21, another embodiment is shown in the form of an electronic gaming machine 300. The electronic gaming machine 300 may include a housing or cabinet 350 and one or more value transfer mechanisms or devices, which may include a coin slot or acceptor 352, a paper currency or bill acceptor 354, a ticket reader/printer 356 and a card reader 358 as illustrated, which may be used to input value to the electronic gaming machine 300. In general terms, a value transfer device may include any device that can accept value from a player, wherein term “value” means credits, gaming tokens, coins, paper, currency, tickets, vouchers, credit cards, debit cards, smart cards, memory devices capable of storing value (e.g., a memory card, smart card, a radio frequency identification (RFID) device, USB key, magnetic card or other electronic storage device) and any other object representative of value, and a value transfer device may include an electronic funds transfer device.

If provided on the electronic gaming machine 300, the ticket reader/printer 356 may be used to read and/or print or otherwise encode ticket vouchers 360. The ticket vouchers 360 may be composed of paper or another printable or encodable material and may have one or more of the following informational items printed or encoded thereon: the casino name, the type of ticket voucher, a validation number, a bar code with control and/or security data, the date and time of issuance of the ticket voucher, redemption instructions and restrictions, a description of an award, and any other information that may be necessary or desirable. Different types of ticket vouchers 360 could be used, such as bonus ticket vouchers, cash-redemption ticket vouchers, casino chip ticket vouchers, extra game play ticket vouchers, merchandise ticket vouchers, restaurant ticket vouchers, show ticket vouchers, etc. The ticket vouchers 360 could be printed with an optically readable material such as ink, or data on the ticket vouchers 360 could be magnetically encoded. The ticket reader/printer 356 may be provided with the ability to both read and print ticket vouchers 360, or it may be provided with the ability to only read or only print or encode ticket vouchers 360. In the latter case, for example, some of the electronic gaming machines 300 may have ticket printers 356 that may be used to print ticket vouchers 360, which could then be used by a player in other electronic gaming machines 300 that have ticket readers 356.

If provided, the card reader 358 may include any type of card reading device, such as a magnetic card reader or an optical card reader, and may be used to read data from a card offered by a player, such as a credit card or a player-tracking card. If provided for player tracking purposes, the card reader 358 may be used to read data from, and/or write data to, player tracking cards that are capable of storing data representing the identity of a player, the identity of a casino, the player's gaming habits, etc.

The electronic gaming machine 300 may include one or more audio speakers 362, a coin payout tray 364, an input control panel 366, and a color video display unit 370 for displaying images relating to the game or games provided by the electronic gaming machine 300. The audio speakers 362 may generate audio representing sounds such as the noise of spinning reels, a dealer's voice, music, announcements or any other audio related to a game. The input control panel 366 may be provided with a plurality of pushbuttons or touch-sensitive areas that may be pressed by a player to select games, make wagers, make gaming decisions, etc. The buttons used may depend on the game or games that could be played on the electronic gaming machine 300. As used herein, the term “button” is intended to encompass any device that allows a player to make an input, such as an input device that must be depressed to make an input selection or a display area that a player may simply touch. For example, the control panel 366 could be generated by the display unit 370. In that case, each of the buttons of the control panel 366 could be a colored area generated by the display unit 370, and some type of mechanism may be associated with the display unit 370 to detect when each of the buttons was touched, such as a touch-sensitive screen.

The electronic gaming machine 300 also may include a mechanism by which the electronic gaming machine 300 may determine the identity of the player. In particular, the card reader 358 may be used to read a card that carries an identification code that may be uniquely associated with the player so that the gaming unit can differentiate that player from all other players, or so that the gaming unit can differentiate that player as a member of a group of players from all player not a member of the group of players. The electronic gaming machine 300 may also include equipment, such as a keypad 384, an input pad 386 (with optional stylus 387), a port (or antenna) 388 adapted to communicate via a wired or wireless link (infrared or radio frequency link, for example) to a mobile electronic device 390 (such as a personal digital assistant, smart phone or tablet), a camera 392, a scanner 394, a retinal (or iris) scanner 396, fingerprint scanner 397, and/or a microphone 398. The electronic gaming machine 300 may include any one of the devices 358, 384, 386, 388, 390, 392, 394, 396, 397, 398, or the electronic gaming machine 300 may include a combination of some or all of the devices 358, 384, 386, 387, 388, 390, 392, 394, 396, 397, 398.

In operation, a player may identify him or herself to the electronic gaming machine 300 by entering a unique numeric or alphanumeric code using the key pad 384, for example. Alternatively, the player may use his or her finger or the stylus 387 to sign his or her signature on the input pad 386. As a further alternative, the player may sign his or her signature on the mobile electronic device 390, which signature is then converted to electronic data, and the data is then transferred via the port/antenna 388 to the electronic gaming machine 300. As yet another alternative, the player may sign his or her signature on a piece of paper that is then photographed using the camera 392 or scanned using the scanner 394 (or the bill acceptor 354) to convert the signature into electronic data. As an additional alternative, the player may place one of his or her fingers or his or her hand on the scanner 397, and the scanner 397 may generate an electronic data representation of the fingerprint on one or more of the player's fingers or an electronic data representation of the pattern of the entire hand. Alternatively, the camera 392 may be used to take a picture (live or still) of the player, the picture then being converted into electronic data. As a still further alternative, the player may place his or her eye up to the retinal (or iris) scanner 396, and the retinal (or iris) scanner 396 may generate an electronic data representation corresponding to the pattern of the retina (or iris) of the player. As yet another alternative, the player may speak into the microphone 398, and characteristics of the spoken words (or voiceprint) may be converted into an electronic data representation.

FIG. 22 is a block diagram of a number of components that may be incorporated in the electronic gaming machine 300. Referring to FIG. 22, the electronic gaming machine 300 may include a controller 400 that may comprise a program memory 402, a microcontroller or microprocessor (MP) 404, a random-access memory (RAM) 406 and an input/output (UO) circuit 408, all of which may be interconnected via an address/data bus 410. It should be appreciated that although only one microprocessor 404 is shown, the controller 400 may include multiple microprocessors 404. Similarly, the memory of the controller 400 may include multiple RAMs 406 and multiple program memories 402. Although the I/O circuit 408 is shown as a single block, it should be appreciated that the I/O circuit 408 may include a number of different types of I/O circuits. The RAM(s) 404 and program memories 402 may be implemented as semiconductor memories, magnetically readable memories, and/or optically readable memories, for example.

FIG. 22 illustrates that the coin acceptor 352, the bill acceptor 354, the ticket reader/printer 356, the card reader 358, the control panel 366, the display unit 370, the keypad 384, the input pad 386 (and optionally the stylus 387), the port/antenna 388, the digital camera 392, the scanner 394, the retinal scanner 396, the fingerprint scanner 397 and the microphone 398 may be operatively coupled to the I/O circuit 408, each of those components being so coupled by either a unidirectional or bidirectional, single-line or multiple-line data link, which may depend on the design of the component that is used. The speaker(s) 362 may be operatively coupled to a sound circuit 412, that may comprise a voice- and sound-synthesis circuit or that may comprise a driver circuit. The sound-generating circuit 412 may be coupled to the I/O circuit 408.

As shown in FIG. 22, the components 352, 354, 356, 358, 366, 370, 384, 386, 387, 388, 392, 394, 396, 397, 398, 412 may be connected to the I/O circuit 408 via a respective direct line or conductor. Different connection schemes could be used. For example, one or more of the components shown in FIG. 9 may be connected to the I/O circuit 408 via a common bus or other data link that is shared by a number of components. Furthermore, some of the components may be directly connected to the microprocessor 404 without passing through the I/O circuit 408.

It will be recognized that other embodiments of the electronic gaming device may include fewer than all of the components illustrated in FIGS. 21 and 22, but greater than the components illustrated in FIGS. 1 and 2. Further, it is possible for embodiments of the electronic gaming device to include components in addition to those illustrated either the embodiment of FIGS. 1 and 2 or the embodiment of FIGS. 21 and 22. These embodiments are provided for exemplary purposes only.

In addition to the awards mentioned above (progressive jackpots, multipliers), the awards that are displayed in the queue may also include elements that provide different types of effects or modifications of the game play determination. In one embodiment, the awards are a predetermined number of free games. In some embodiments, the awards are at least one or more a win multiplier, wild multipliers, bonus wilds, symbols that cause the award of additional free games, trigger symbols to retrigger the at least two second arrays, held columns, random wild symbols, stacked symbols, bonus symbols, new game symbols, reveal symbols, progressives, bonus credits, jackpot symbols, and one or more symbol replacements. A variety of awards can be provided, including:
a predetermined number of free plays of he game;
multipliers that multiply the amount of any win from one of the predetermined winning combinations;
“wild” symbols that cause the display of substitute symbols in randomly selected symbol positions;
bonus symbols that awards a bonus prize, either as a monetary amount or as a bonus credit;
wild multiplier symbols that cause the display of substitute symbols on the array 144 and multiplies the amount of any win from one of the predetermined winning combinations;
bonus wild symbols that cause the display of substitute symbols on the array 144 and awards a bonus prize;
symbols that cause the award of additional free plays of the game;
symbols that cause one or more of the symbol positions to be held static (typically one or more reels 142) and display substitute symbols on the array 144;
symbols that cause the same game symbol to be stacked in a group of symbol positions, typically the group being one or more reels 142;
symbols that cause the display of new game symbols on the array 144;
“reveal” symbols that cause a game symbol to reveal another game symbol; and
“replacement” symbols that cause one or more game symbols to be replaced by other game symbols in the array 144.

So, in some embodiments, the lowest order award is removed from the queue after indexing, and another award is added to the queue after the highest order award.

In some embodiments, two or more awards are removed from the queue and two or more awards are added to the queue to change the displayed set.

In some embodiments, the set of two or more awards is replaced with another set of two or more awards when the determination is made whether the trigger event associated with the highest order award in the displayed set has occurred.

In some embodiments, the queue comprises a linear list of the two or more awards, and an indicator is displayed aligned with the lowest order award in the linear list prior to indexing and the indicator is displayed aligned with a second award in the linear list after indexing. Alternatively, the queue comprises a circular array of the two or more awards, and an indicator is displayed aligned with the lowest order award in the circular list prior to indexing and the indicator is displayed aligned with a second award in the circular list after indexing.

In some embodiments, the subsequent award and the previous award are adjacent in the queue. Alternatively, the subsequent award and the previous award are not adjacent in the queue.

In some embodiments, multiple individual instances of an award appear in the queue.

In some embodiments, the set of two or more awards comprises a set of two or more progressive jackpots with a lowest order progressive jackpot corresponding to the lowest order award and a highest order progressive jackpot corresponding to the highest order award.

In some embodiments, the first game comprises one or more configurations of game symbols, the game symbols arranged in a plurality of reels, with one or more of the configurations of game symbols arranged along a payline associated with a game outcome, the game outcome being associated with a value award. Preferably, the trigger even associated with each award in the set comprises a configuration of the game symbols in the first game.

In some embodiments, the queue comprises a linear list. Alternatively, the queue comprises a circular array.

In some embodiments, the subsequent award and the previous award are adjacent in the queue. Alternatively, the subsequent award and the previous award are not adjacent in the queue.

In some embodiments, the two or more awards in the set are randomly selected.

In some embodiments, each individual instance of award is a progressive jackpot selected from the group comprising a mini progressive jackpot, a minor progressive jackpot, a major progressive jackpot, and a grand jackpot

In conclusion, although the preceding text sets forth a detailed description of different embodiments of the invention, it should be understood that the legal scope of the invention is defined by the words of the claims set forth at the end of this patent. The detailed description is to be construed as exemplary only and does not describe every possible embodiment of the invention since describing every possible embodiment would be impractical, if not impossible. Numerous alternative embodiments could be implemented, using either current technology or technology developed after the filing date of this patent, which would still fall within the scope of the claims defining the invention.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. § 112(f).

What is claimed is:

1. A gaming machine comprising:
at least one display;
a value input comprising at least one of a coin acceptor, a bill acceptor and a ticket reader; and
at least one electronic controller coupled to the at least one display and the value input, the at least one controller configured:
to determine if a wager has been received via the value input;
to display a first game on the at least one display including one or more configurations of game symbols if a wager has been received, one or more of the configurations of game symbols being associated with a game outcome, the game outcome being associated with a value award payable to a player;
to display a set of two or more awards on the at least one display separate from the first game,
each award in the set associated with a trigger event, wherein if the trigger event occurs, the award is provided to the player,
each award in the set displayed in a queue from a lowest order award to a highest order award in the set according to when a determination will be made whether the trigger event associated with each award has occurred;
to index to a subsequent award in the set and display the index to the subsequent award each time a determination is made whether the trigger event associated with a previous award has occurred; and
to change the displayed set at least when the determination is made whether the trigger event associated with the highest order award in the displayed set has occurred.

2. The gaming machine according to claim 1, wherein the lowest order award is removed from the queue after indexing, and another award is added to the queue after the highest order award.

3. The gaming machine according to claim 1, wherein two or more awards are removed from the queue and two or more awards are added to the queue to change the displayed set.

4. The gaming machine according to claim 1, wherein the set of two or more awards is replaced with another set of two or more awards when the determination is made whether the trigger event associated with the highest order award in the displayed set has occurred.

5. The gaming machine according to claim 1, wherein the queue comprises a linear list of the two or more awards, and an indicator is displayed aligned with the lowest order award in the linear list prior to indexing and the indicator is displayed aligned with a second award in the linear list after indexing.

6. The gaming machine according to claim 1, wherein the queue comprises a circular array of the two or more awards, and an indicator is displayed aligned with the lowest order award in the circular list prior to indexing and the indicator is displayed aligned with a second award in the circular list after indexing.

7. The gaming machine according to claim 1, wherein the subsequent award and the previous award are adjacent in the queue.

8. The gaming machine according to claim 1, wherein the subsequent award and the previous award are not adjacent in the queue.

9. The gaming machine according to claim 1, wherein multiple individual instances of an award appear in the queue.

10. The gaming machine according to claim 1, wherein the set of two or more awards comprises a set of two or more progressive jackpots with a lowest order progressive jackpot corresponding to the lowest order award and a highest order progressive jackpot corresponding to the highest order award.

11. The gaming machine according to claim 1, wherein the first game comprises one or more configurations of game symbols, the game symbols arranged in a plurality of reels, with one or more of the configurations of game symbols arranged along a payline associated with a game outcome, the game outcome being associated with a value award.

12. The gaming machine according to claim 11, wherein the trigger even associated with each award in the set comprises a configuration of the game symbols in the first game.

13. A gaming machine comprising:
at least one electronic video display;
a value input comprising at least one of a coin acceptor, a bill acceptor and a ticket reader; and
at least one electronic controller coupled to the at least one electronic video display and the value input, the at least one controller configured:
to determine if a wager has been received via the value input;
to display a first game on the at least one electronic video display if a wager has been received,
a play of the first game including a plurality of randomly selected game symbols arranged in a plurality of reels, one or more of the configurations of the randomly selected game symbols arranged along a payline being associated with a game outcome, the game outcome being associated with a value award payable to a player;
to display a set of two or more awards on the electronic video display contemporaneous with and separate from the first game,
each award in the set associated with a trigger event displayed as part of the first game, wherein if the trigger event occurs, the award is provided to the player,
each award in the set displayed in a queue starting with a present award according to when a determination will be made whether the trigger event associated with each award has occurred during a play of the first game;
to index to a subsequent award in the set and display the index to the subsequent award on the electronic video display after each play of the first game; and
to remove the present award from the set and add a new award to the set after the determination is made whether the trigger event associated with the present jackpot has occurred in the first game, and to remove an award from the set and add a new award to the set after each subsequent play of the first game.

14. The gaming machine according to claim 13, wherein the queue comprises a linear list.

15. The gaming machine according to claim 13, wherein the queue comprises a circular array.

16. The gaming machine according to claim 13, wherein the subsequent award and the previous award are adjacent in the queue.

17. The gaming machine according to claim 13, wherein the subsequent award and the previous award are not adjacent in the queue.

18. The gaming machine according to claim 13, wherein the two or more awards in the set are randomly selected.

19. The gaming machine according to claim 13, wherein each individual instance of award is a progressive jackpot selected from the group comprising a mini progressive jackpot, a minor progressive jackpot, a major progressive jackpot, and a grand jackpot.
